(19) United States
(12) Patent Application Publication
(10) Pub. No.: US 2022/0325169 A1
(43) Pub. Date: Oct. 13, 2022

(54) MULTIFUNCTIONAL ADDITIVE FOR USE IN WELLBORE SERVICING

(71) Applicants: Jun Su An, Houston, TX (US); Jason Helander, Richmond, TX (US); Paul Schuber, Sugar Land, TX (US); Andrew Mordh, Roanoke, TX (US); Tom Swanson, Houston, TX (US); Chris Arceo, Richmond, TX (US); David Laperouse, Abbeyville, LA (US); William Crimmins, Jenks, OK (US)

(72) Inventors: Jun Su An, Houston, TX (US); Jason Helander, Richmond, TX (US); Paul Schuber, Sugar Land, TX (US); Andrew Mordh, Roanoke, TX (US); Tom Swanson, Houston, TX (US); Chris Arceo, Richmond, TX (US); David Laperouse, Abbeyville, LA (US); William Crimmins, Jenks, OK (US)

(73) Assignee: SOLUGEN, INC., Houston, TX (US)

(21) Appl. No.: 17/631,364

(22) PCT Filed: Aug. 12, 2020
(86) PCT No.: PCT/US20/46031

§ 371 Date: Jan. 28, 2022

Related U.S. Application Data
(60) Provisional application No. 62/885,684, filed on Aug. 12, 2019.
(60) Provisional application No. 62/885,688, filed on Aug. 12, 2019.
(60) Provisional application No. 62/890,738, filed on Aug. 23, 2019.

(51) Int. Cl. C09K 8/54; C09K 8/03

(52) U.S. Cl. CPC C09K 8/54; C09K 8/03; C09K 2208/32

(57) ABSTRACT

A multifunctional wellbore servicing additive composition includes a biochelant and at least one compound selected from the group consisting of acid, oxidizer, protectant, and surfactant. A method of servicing an oilwell includes placing downhole a composition comprising a biochelant and at least one compound selected from the group consisting of acid, oxidizer, protectant, and surfactant.

### CROSS-REFERENCE TO RELATED APPLICATIONS

The present application is a 35 U.S.C. § 371 national stage application of PCT/US2020/046031, and entitled “Multifunctional Additive for Use in Wellbore Servicing,” filed Aug. 12, 2020, which claims priority to U.S. Provisional Patent Application No. 62/885,684 filed Aug. 12, 2019 and entitled “Biochelant-Based Corrosion Inhibitor Compositions;” U.S. Provisional Patent Application No. 62/885,688 filed Aug. 12, 2019 and entitled “Multifaceted Additives for Oxidation and Metal Chelation;” and U.S. Provisional Patent Application No. 62/890,738 filed Aug. 23, 2019 and entitled “Completion Acid Composition”, each of which is incorporated herein by reference in its entirety for all purposes.

### TECHNICAL FIELD

The present disclosure relates to compositions and methods for use in wellbore servicing. More specifically, the present disclosure relates to a multifunctional well servicing additive.

### BACKGROUND

The lifecycle of oil and gas wells can be broken into five stages: (i) planning; (ii) drilling; (iii) completion; (iv) production; and (v) abandonment. While each of these activities is important to resource recovery and beneficial economics of the well operation; effective completion and production operations are considered major determinants of the amount of resource recovered from any well.

Well completion refers to various operations to prepare a well for production and may include casing, cementing, perforating, stimulating, gravel packing, hanging production tubing, and installing a Christmas tree at the wellhead. In short, well completion simply means deeming the well a commercially viable operation and then preparing the well for production. A widely held view is that completion begins when a drill bit first makes contact with a producing reservoir.

The major types of well completions are open-hole completions, perforated completions, and offshore completions. Open-hole completions require no production casing or liners. Instead the well fluid enters the wellbore and flows freely to the surface via the intermediate casing. Perforated completions are by far the most common completion method. Perforating is the process of piercing the production casing at specific locations to allow the formation fluids to enter the wellbore and flow to the surface. Offshore completion techniques and equipment are much like those based on land in that both require some type of multi-valve system to regulate flow rates and pressures and minimize the risk of blow-outs.

Regardless of the quantity of hydrocarbons present, oil and gas wells do not always behave as designed. Some require additional treatments to enhance their production. For example, in tight formations with low permeability, fracturing is used to physically crack the rock and create a greater region of flow between the wellbore and the formation. These techniques are collectively termed well stimulation and the most common methods are acidizing, explosives and hydraulic fracturing.

Acidizing relies on chemical reactions with the surrounding formations. This method is most effective on carbonate (limestone and dolomite) reservoirs. A cocktail of various chemicals are injected into the well to dissolve the formation and release additional hydrocarbons. Explosives are used to create the fractures in reservoirs that are difficult to fracture. Using explosives is a costly process and as a result, are most often used on larger wells that have the capability of justifying the expense. Hydraulic fracturing is the application of high pressure forcing massive amounts of either oil or water into the formations that surround a reservoir. Commonly referred to as a “frac job” this pressure causes the formations to break apart causing additional well fluid channels to open up which releases more fluid. Hydraulic fracturing is used in “mature” fields and in a great deal of horizontal wells (especially shales).

Throughout the completion and production operations for oil and gas well, various additives are introduced to facilitate these resource recovery operations. An ongoing need exists for additives that are environmentally-sound materials that can effectively facilitate these resource recovery operations.

### SUMMARY

Disclosed herein is a multifunctional wellbore servicing additive composition comprising a biochelant and at least one compound selected from the group consisting of acid, oxidizer, protectant, and surfactant.

Also disclosed herein is a method of servicing an oilwell comprising placing downhole a composition comprising a biochelant and at least one compound selected from the group consisting of acid, oxidizer, protectant, and surfactant.

### BRIEF DESCRIPTION OF DRAWINGS

For a detailed description of the aspects of the disclosed processes and systems, reference will now be made to the accompanying drawings in which:

FIG. 1 depicts chemical structures of exemplary biochelants.

FIG. 2 is a process flow diagram for utilization of chlorine-dioxide corrosion inhibitor of the type disclosed herein.

FIG. 3 is a plot of sample conductivity as a function of pH for the samples from Example 1.

### DETAILED DESCRIPTION

Disclosed herein are compositions for use in facilitating resource recovery during wellbore servicing operations. In one or more aspects, the compositions disclosed herein may be employed in any aspect of wellbore servicing compatible with a user and/or process goal. In an aspect, the compositions disclosed herein are used in well completion operations, well production operations or both. Herein such compositions are termed Multifunctional Well Servicing Additives or MWSAs.

In an aspect, a MWSA comprises a biochelant and at least one compound selected from the group consisting of an acid, an oxidizer, a protectant, and a surfactant. In an alternative aspect, a MWSA comprises a biochelant and at least two compounds selected from the group consisting of an acid, an oxidizer, a protectant, and a surfactant. In either aspect, the MWSA may further comprise a solvent.

Aspects disclosed herein may provide the materials listed as suitable for satisfying a particular feature of the aspect delimited by the term “or.” For example, a particular feature of the disclosed subject matter may be disclosed as follows: Feature X can be A, B, or C. It is also contemplated that for each feature the statement can also be phrased as a listing of alternatives such that the statement “Feature X is A, alternatively B, or alternatively C” is also an aspect of the present disclosure whether or not the statement is explicitly recited.

The terms “conduit” and “line” are interchangeable, and as used herein, refer to a physical structure configured for the flow of materials therethrough, such as pipe or tubing. The materials that flow in the “conduit” or “line” can be in a gas phase, a liquid phase, a solid phase, or a combination of these phases as usually termed “multi-phase flow.”

In an aspect, the MWSA comprises a chelant. Herein a chelant, also termed a sequestrant or a chelating agent, refers to a molecule capable of bonding a metal. The chelating agent is a ligand that contains two or more electron-donating groups so that more than one bond is formed between each of the atoms on the ligand to the metal. This bond can also be dative or a coordinating covalent bond meaning the electrons from each electronegative atom provides both electrons to form the bond to the metal center. a metal ion and the ligand. In an aspect, the chelant is a biochelant. As used herein, the prefix “bio” indicates that the chemical is produced by a biological process such as through the use of an enzyme catalyst.

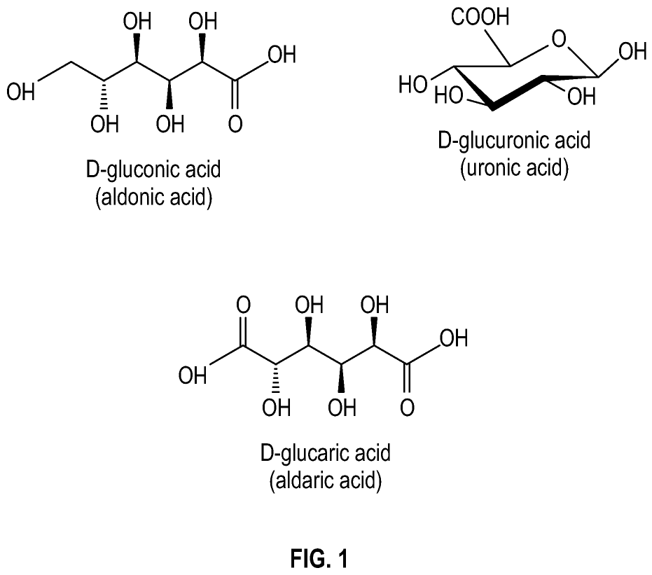

In an aspect, the biochelant comprises an aldonic acid, uronic acid, aldaric acid or combination thereof and a counter cation. Structures of these biochelants are depicted in FIG. 1. The counter cation may comprise an alkali metal (Group I), an alkali earth metal (Group II) or combinations thereof. In certain aspects, the counter cation is sodium, potassium, magnesium, calcium, strontium, as well as cesium.

In an aspect, the biochelant comprises a glucose oxidation product, a gluconic acid oxidation product, a gluconate or combination thereof. The glucose oxidation product, gluconic acid oxidation product or combination thereof may be buffered to a pH in the range of from about 05 to about 5.5 using a pH adjusting material in an amount of from about 1 weight percent (wt. %) to about 10 wt. %, alternatively from about 1 wt. % to about 3 wt. %, or alternatively from about 5 wt. % to about 9 wt. % based on the total weight of the biochelant. In an aspect, the biochelant comprises from about 1 wt. % to about 8 wt. % of a caustic solution in a 20 wt. % gluconate solution.

Alternatively, the biochelant comprises a buffered glucose oxidation product, a buffered gluconic acid oxidation product or combinations thereof. In such aspects, the buffered glucose oxidation product, the buffered gluconic acid oxidation product or combinations thereof are buffered to a pH within a range disclosed herein with any suitable acid or base such as sodium hydroxide. In such aspects, the biochelant comprises a mixture of gluconic acid and glucaric acid and further comprises a minor component species comprising n-keto-acids, C₂-C₅ diacids or combinations thereof. In an aspect, the biochelant comprises Biochelate™ metal chelation product commercially available from Solugen, Houston Tex.

In an aspect, the MWSA is prepared as a concentrate having the biochelant present in an amount of from about 1 wt. % to about 70 wt. %, alternatively from about 20 wt. % to about 70 wt. %, alternatively from about 1 wt. % to about 10 wt. % or alternatively about 10 wt. % to about 50 wt. % based on the total weight of the MWSA. In an alternative aspect, the MWSA is introduced to a wellbore servicing fluid being introduced to a wellbore. In such aspects, the MWSA has biochelant is present in an amount of from about 0.01 wt. % to about 5 wt. %, alternatively from about 0.5 wt. % to about 3 wt. % or alternatively from about 1 wt. % to about 2 wt. % based on the total weight of the wellbore servicing fluid.

In an aspect, the MWSA comprises an acid. In an aspect, the acid comprises hydrochloric acid, hydrobromic acid, sulfuric acid, nitric acid, phosphoric acid, boric acid, malonic acid, citric acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid, Tall oil fatty acid (TOFA) as well as mixtures of pure and impure acids contained in this feed stock or waste stream, liquid rosin, and dimer acids as well or combinations thereof. In an aspect, the MWSA is prepared as a concentrate having the acid present in an amount of from about 0.01 wt. % to a about 50 wt. %, alternatively from about 5 wt. % to about 28 wt. %, alternatively from about 28 wt. % to about 50 wt. %, or alternatively about 0.01 wt. % to about 5 wt. % based on the total weight of the MWSA. In an alternative aspect, the MWSA is introduced to a wellbore servicing fluid being introduced to a wellbore. In such aspects, the MWSA has acid present in an amount of from about 0.001 wt. % to about 50 wt. %, alternatively from about 5 wt. % to about 28 wt. %, alternatively from about 28 wt. % to about 50 wt. %, or alternatively about 0.001 wt. % to about 5 wt. % based on the total weight of the wellbore servicing fluid. In an aspect, an acid suitable for use in the present disclosure has the chemical structure of HO(O)C(CH)ₙCH₂OH where n can be comprised of an alkyl chain having from about 3 to about 18 carbons. Alternatively, the acid can be a mono acid with the structure of HO(O)C(CR)ₙCH₂OH, where n can be comprised of an alkyl chain from having from about 3 to about 18 carbon, R can be H or any heteroatoms that is more electronegative than carbon. In an aspect, the acid is a diacid with the chemical structure of HO(O)C(CH)ₙC(O)OH where n can be comprised of a carbon backbone from C₃ to C₁₈, or a diacid with the structure of HO(O)C(CR)ₙC(O)OH where n can be comprised of an alkyl chain from about 3 to about 18 carbons. In such aspects, R can be H or any heteroatoms that is more electronegative than carbon, or combinations thereof. In an aspect, the MWSA is prepared as a concentrate having the acid present in an amount of from about 80 wt. % to about 0.5 wt. %, alternatively from about 0.5 wt. % to about 75 wt. %, or alternatively about 0.05 wt. % to about 50 wt. % based on the total weight of the MWSA. In an alternative aspect, the MWSA is introduced to a wellbore servicing fluid being introduced to a wellbore. In such aspects, the MWSA has acid present in an amount of from about 0.01 wt. % to about 5 wt. %, alternatively from about 0.01 wt. % to about 3 wt. %, or alternatively from about 0.01 wt. % to about 1 wt. % based on the total weight of the wellbore servicing fluid.

In an aspect, the MWSA comprises an oxidizing agent. Oxidizing agents suitable for use in the present disclosure may comprise hydrogen peroxide or contain a peroxy bond (—O—) and release hydrogen peroxide upon reaction with water. In one or more aspects, the oxidizing agent comprises hydrogen peroxide, dicumyl peroxide, benzoyl peroxide, di-t-butyl peroxide, t-butyl hydroperoxide, a per-carboxylic acid, a peroxy acid, a perester, dialkyl peroxides, 2,5-dimethyl-2,5-di-(t-butylperoxy) hexane, diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, t-amyl peroxides, n-butyl-4,4-di-(t-butyl peroxy) valerate, di-t-butyl peroxide, 2,5-dimethyl-2,5-di-(t-butylperoxy) hexane (DHBP), diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, diacyl peroxides, t-amyl peroxides, n-butyl-4,4-di-(t-butyl peroxy) valerate, and the like, or combinations thereof. In an aspect, the oxidizing agent comprises hydrogen peroxide, peracetic acid or combination thereof.

Alternatively, the oxidizing agent comprises a salt having X waters of crystallization wherein X is equal to or greater than 1 and wherein at least one of the waters of crystallization has been replaced with hydrogen peroxide. Such salts may be represented by the general formula Y.nH₂O.mH₂O₂ wherein Y is a salt, n is equal to or greater than zero and m is equal to or greater than 1. Examples of oxidizing agents which contain a peroxy bond and release hydrogen peroxide only upon reaction with water include without limitation perphoshate [(P₂O₈)⁴⁻], persulfate [(S₂O₈)²⁻], and perborate [(BO₃)⁻] salts of alkali metals, alkaline earth metals and ammonium ion.

The oxidizing agent may be present in the MWSA concentrate in an amount of from about 3 wt. % to about 50 wt. %, alternatively, from about 20 wt. % to about 34 wt. %, alternatively from about 34 wt. % to about 50 wt. % or alternatively from about 3 wt. % to about 8 wt. % based on the total weight of the MWSA. In aspects where the MWSA is introduced to a wellbore servicing fluid, the MWSA has oxidizing agent present in an amount of from about 1 wt. % to about 20 wt. %, alternatively from about 2 wt. % to about 15 wt. % or alternatively from about 5 wt. % to about 10 wt. % based on the total weight of the wellbore servicing fluid.

In an aspect, the MWSA comprises a surfactant. Surfactants are compounds that display a dual nature, with affinity to both brine and hydrocarbon phases. In the presence of brine and oil, surfactants will position at the interface to form a molecular bridge between the brine and hydrocarbons, which then lowers the interfacial tension to near zero values (less than10⁻³ mN/m). This is equivalent to saying the phases behave as almost fully miscible.

Nonlimiting examples of surfactants suitable for use in the MWSA include ethoxylated nonyl phenol phosphate esters, nonionic surfactants, cationic surfactants, anionic surfactants, amphoteric/zwitterionic surfactants, sulfonated olefins, alkyl glucoside, quaternary amine, alkyl phosphonium chloride, alkyl phosphonate surfactants, linear alcohols, nonylphenol compounds, alkyoxylated fatty acids, alkylphenol alkoxylates, ethoxylated amides, betaines, methyl ester sulfonates, hydrolyzed keratin, sulfosuccinates, taurates, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, quaternary ammonium compounds, trimethyltallowammonium chloride, trimethylcocoammonium chloride, quaternary alkyl ammonium chloride, alkyl phosphonium chloride or combinations thereof. In an aspect, the surfactant is a cationic-film forming surfactant such as amines, ethoxylated amines, propargyl alcohol, acetylenic alcohol, phosphate esters, quarternary amines, imidazolines, amine salts, amide salts and combinations thereof.

The surfactant may be present in an MWSA concentrate in an amount of from about 0.1 wt. % to about 70 wt. %, alternatively from about 0.1 wt. % to about 10 wt. %, alternatively from about 4 wt. % to about 8 wt. % or alternatively from about 50 wt. % to about 70 wt. % based on the total weight of the MWSA. In aspects where the MWSA is introduced to a wellbore servicing fluid, the MWSA has surfactant present in an amount of from about 0.01 wt. % to about 2 wt. %, alternatively from about 0.1 wt. % to about 1 wt. % or alternatively from about 0.5 wt. % to about 1 wt. % based on the total weight of the wellbore servicing fluid.

In an aspect, the MWSA further comprises a protectant. Herein the protectant may function to inhibit scale or corrosion through any number of mechanisms. For example, the protectant may react with dissolved materials in industrial water to form a very thin coating or microscopic film. In other instances, the protectant may function to sequester metals from the water.

In an aspect, the protectant comprises phosphonates, organic acids, polymeric organic acids, polycarboxylics, ATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid and sodium aspartic acid, phosphinocarboxylates, AA-AMPS (acrylic acid-2-acrylamido-2-methylpropane sulfonic acid), phosphonate esters, cocamines, fatty acid amides, fatty acid derived imidazoles, acetylenic alcohol, thiazoles, triazoles, pyrazoles, pyridine and derivatives thereof and any combinations thereof. In an aspect, the protectant comprises acetylenic acid, phosphate esters, poly/orthophosphates, phosphonates, zinc, nitrite, molybdate compounds, azoles, silicates, or combinations thereof.

In an aspect, the protectant may be present in an MWSA concentrate in an amount of from about 0.2 wt. % to about 70 wt. %, alternatively from about 0.5 wt. % to about 50 wt. % or alternatively from about 1 wt. % to about 10 wt. %. In aspects where the MWSA is introduced to a wellbore servicing fluid, the MWSA has protectant present in an amount of from about 0.5 wt. % to about 5 wt. %, alternatively from about 0.5 wt. % to about 3 wt. % or alternatively from about 1 wt. % to about 2 wt. % based on the total weight of the wellbore servicing fluid.

In an aspect, the MWSA optionally comprises a solvent. In some aspects the solvent comprises C₂ to C₂₀ ethers, C₂ to C₂₀ carbonates, C₂ to C₂₀ esters, C₂ to C₂₀ ketones, C₂ to C₂₀ aldehydes, C₂ to C₂₀ alcohols or combinations thereof. Alternatively, the solvent comprises a C₂ to C₂₀ alcohol. Nonlimiting examples of alcohols suitable for use in the present disclosure include methanol, ethanol, propanol, butanol, pentanol, isopropanol, ethylene glycol, propylene glycol and combinations thereof. Alternatively, the solvent comprises water.

Solvent may be present in the MWSA in an amount sufficient to provide a composition having suitable rheological properties to meet some user or process goal.

In an aspect, an MWSA of the present disclosure functions as an iron control agent during wellbore servicing operations such as a well completion operation. In such aspects, the MWSA comprises a biochelant, an acid, a surfactant and a protectant, each of the type previously disclosed herein. For example, the MWSA may comprise hydrochloric; a biochelant; a surfactant such as a linear alcohol ethoxylate; and a protectant such as propargyl alcohol. In such an aspect, the MWSA may function as an iron control agent having a wide effective pH range of from about 0 to about 2, alternatively from about 2 to about 4 or alternatively from about 3 to about 8. Herein a wide effective pH range refers to the pH at which the materials are able to remain in solution and prevent the formation of a precipitate that is detrimental to the well servicing operation.

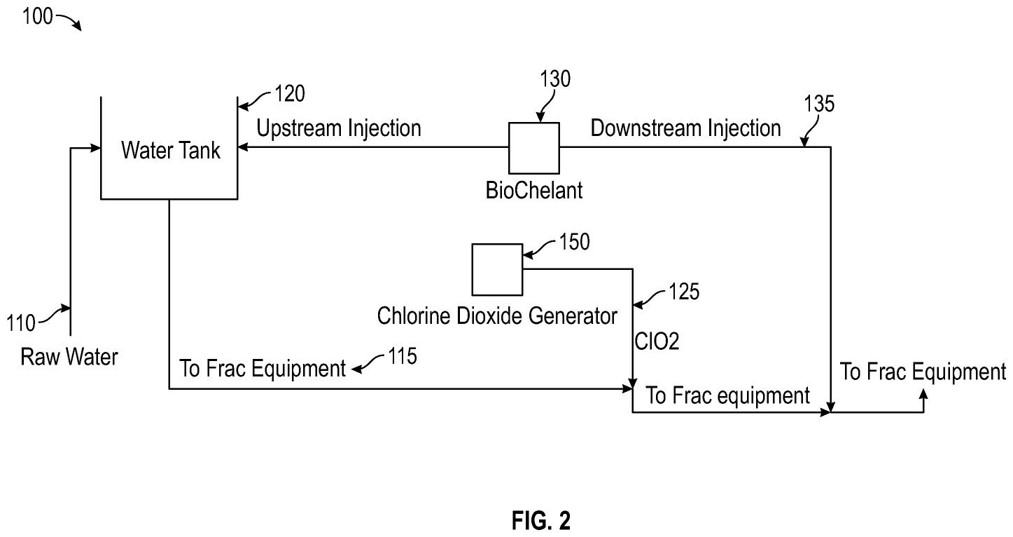

In an aspect, the MWSA functions to inhibit chlorine dioxide induced corrosion. In such aspects, the MWSA may comprise a biochelant of the type disclosed herein. For example, FIG. 2 depicts a process flow diagram for the treatment of process water, 100. Referring to FIG. 2, flow water may be conveyed to water tank 120 via conduit 110. A MWSA of the type disclosed herein may be introduced to the water tank 120 from a vessel storing biochelant 130 which is disposed upstream of chlorine dioxide generator 150. The treated water may be conveyed via conduit 115 to conduit 125 where it may intermingle with effluent from the chlorine dioxide generator before being conveyed to the fracing equipment. In the alternative, the MWSA is conveyed via conduit 135 to the fracing equipment. In yet another aspect, not depicted, the system may further comprise an oxidizing agent tank containing one or more oxidizing agents of the type disclosed herein. For example, the system may comprise a tank containing an oxidizer (e.g., peracetic acid) in fluid communication with both the fracing equipment and water tank 120. The oxidizing agent may be included in the system 100 with the chlorine dioxide vessel 150 depicted in FIG. 2 or in lieu of that vessel.

In an aspect, the MWSA functions to inhibit oxidizer-induced corrosion. In such aspects, the MWSA comprises biochelant, a cationic film-forming surfactant and a solvent, each of the type disclosed previously herein. For example, the MWSA may comprise the biochelant, an ethoxylated amine and water. In such aspects, the MWSA may be used to treat produced water (e.g., blackwater).

In an aspect, the MWSA functions as an oxidizer, a metal chelator (e.g., Fe³⁺) and a biocide. Herein a biocide refers to a chemical intended to destroy, deter, render harmless, or exert a controlling effect on any harmful organism. In such aspects, the MWSA comprises a biochelant, a peroxide and a solvent, each of the type disclosed previously herein. For example, the MWSA may comprise the biochelant, hydrogen peroxide and water.

In an aspect, a method is provided to introduce a MWSA into a well servicing operation such as a well completion or production operation. The MWSA when introduced may provide a number of benefits to the well servicing operation. In an aspect, the compositions and methods of the present disclosure may function to reduce corrosion, inhibit bacterial formation and decrease soluble metal species (e.g., iron). In some aspects, a MWSA is used to mitigate detrimental materials in a produced water. In other aspects, a MWSA is used to inhibit the formation of or mitigate corrosion found in well bore servicing equipment either above ground or downhole. For example, a MWSA of the type disclosed herein may protect surface iron, thereby extending the life of surface iron and fracturing equipment.

### EXAMPLES

The subject matter having been generally described, the following examples are given as particular aspects of the disclosure and are included to demonstrate the practice and advantages thereof, as well as aspects and features of the presently disclosed subject matter. It should be appreciated by those of skill in the art that the techniques disclosed in the examples which follow represent techniques discovered by the inventors to function well in the practice of the present subject matter, and thus can be considered to constitute preferred modes for its practice. However, those of skill in the art should, in light of the present disclosure, appreciate that many changes can be made in the specific aspects which are disclosed and still obtain a like or similar result without departing from the scope of the instant disclosure. It is understood that the examples are given by way of illustration and are not intended to limit the specification of the claims to follow in any manner.

### EXAMPLE 1

To quantify the corrosion inhibition effects of the biochelate, linear polarization resistance (LPR) measurements were conducted on a metal coupon sample for 20 hours. Coupons were sonicated for 3 minutes each in xylenes, IPA, and acetone to clean the samples. Coupons remained in acetone until they were introduced to the brine (a solution of NaCl at 30,000 mg/L) at the start of the test.

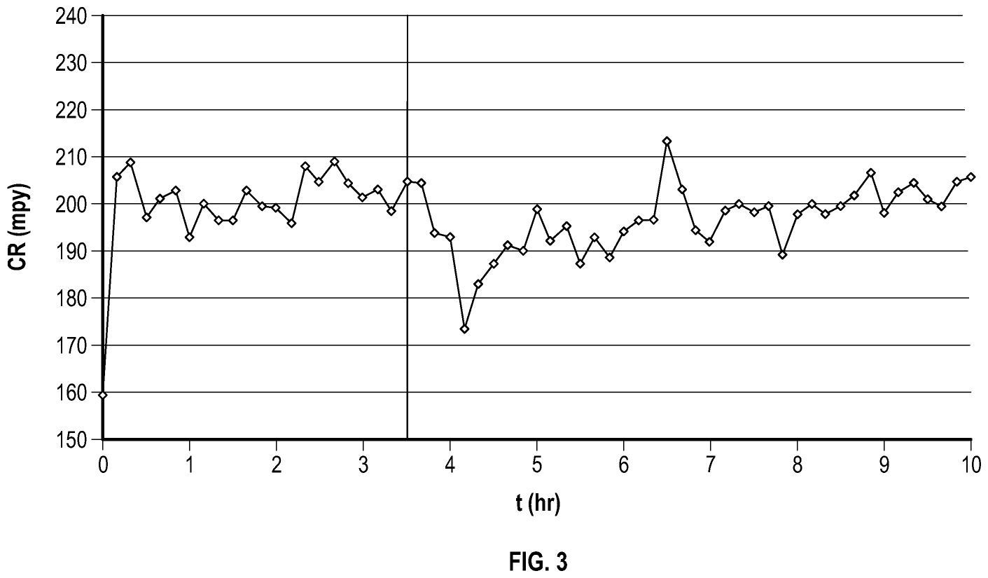

The brine solutions were sparged with carbon dioxide before being heated to 60° C. after which the sample soluton was added to a glass cell. Immediately a C1018 low carbon steel coupon (working electrode), Ag/AgCl electrode (reference electrode and graphite electrode (counter electrode) were inserted in the sample with carbon dioxide sparging. The sample solution was then stirred at 100 rpm and an initial LPR reading and measure of the open circuit potential before linear polarization was taken. The LPR measurements were taken every 10 minutes for the duration of the experiment. A corrosion inhibitor was introduced to the sample after 3.5 hours. The results are presented in FIG. 3.

Referring to FIG. 3, the addition of the biochelate yields a drop in corrosion rate from approximately 205 mpy to a minimum of 175 mpy. This reduction in corrosion rate was noted for approximately 1 hour.

### EXAMPLE 2

The iron chelating ability of compositions of the present disclosure were further investigated by comparing the chelation ability of an iron solution using an MWSA to that of citric acid. Three samples were prepared. The first sample, Sample 1, contained 15 wt. % of an MWSA while the second sample, Sample 2, contained 30 wt. % of an MWSA. Sample 3 contained 50% citric acid. Samples were prepared by adding 5 g of a 0.1 M Fe(III)Cl₃ solution and 0.2 mL of biochelant to each formulation and the pH of the solution measured. Sodium hydroxide was used to titrate the sample to pH of 8. As insoluble iron is orange, the solution will turn more orange as more iron falls out. Samples 1 and 3 were comparable in color and turbidity, while Sample 3 was noticeably clearer and less orange. The results demonstrate the Sample 3 containing 30 wt. % MWSA performed better than citric acid in iron chelation.

### EXAMPLE 3

The ability of an MWSA to inhibit chlorine-dioxide induced corrosion was investigated. Coupons were cleaned with sonication at 5 minute intervals in xylene, IPA and acetone and then weighed and measured before testing. A corrosive chlorine dioxide was made by combination of the materials of the type and in the amounts presented in Table 1.

TABLE 1

| Chemical | Vol % |
|---|---|
| 25% Sodium Chlorite | 44.00% |
| 12.5% Bleach | 40.00% |
| 20° Baume HCl | 16.00% |
| Total | 100.00% |

Samples of water and brine (3 wt. % NaCl) were dosed with 10 ppm of chlorine dioxide to achieve corrosive chlorine dioxide solution with an ORP reading of 700-750 mV. The coupons were then submerged into the corrosive chlorine dioxide solution for 24 hours. The results from the tests are presented in Table 2.

As seen in the Table 2, it is clear that the addition of the biochelant results in a significant decrease in the rate of chlorine dioxide induced corrosion. This is particularly the case with iron and sodium gluconate in the presence of 3% NaCl. Furthermore, the addition of the biochelant was observed to result in a clearer, precipitant free solution. It was observed that the control sample (no biochelant) resulted in a yellow-orange precipitant at the bottom of the reaction vessel. This precipitant is concerning, as it will not be filtered in the field. As a result, these solids will travel down to the well and the formation of interest, plugging up perforations and porous zones. Furthermore, these solids can act as nucleation points for scale and sludge, which will lead to an increase in solid deposition, ultimately leading to lower hydrocarbon production from the well.

TABLE 2

| | Initial | Weight After | Weight | Corrosion | |
|---|---|---|---|---|---|
| | Weight (g) | Test (g) | Loss (mg) | Rate (mpy) | % Improvement |
| CIO2 in DI H2O | 12.035 | 12.029 | 5.500 | 4.551 | N/A |
| Sodium | 11.945 | 11.942 | 2.900 | 2.369 | 48% |
| Gluconate @ 500 | | | | | |
| ppm in DI H2O | | | | | |
| Copper | 11.937 | 11.933 | 4.200 | 3.441 | 24% |
| Gluconate @ 500 | | | | | |
| ppm in DI H2O | | | | | |
| Iron Gluconate @ | 11.960 | 11.957 | 3.200 | 2.617 | 43% |
| 500 ppm in DI | | | | | |
| H2O | | | | | |
| CIO2 in 3% NaCl | 11.960 | 11.956 | 4.000 | 3.278 | N/A |
| brine | | | | | |
| Sodium | 12.007 | 12.004 | 3.200 | 2.640 | 19% |
| Gluconate @ 500 | | | | | |
| ppm in 3% NaCl | | | | | |
| brine | | | | | |
| Copper | 11.934 | 11.929 | 4.800 | 3.921 | −20% |
| Gluconate @ 500 | | | | | |
| ppm in 3% NaCl | | | | | |
| brine | | | | | |
| Iron Gluconate @ | 11.909 | 11.906 | 3.000 | 2.461 | 25% |
| 500 ppm in 3% | | | | | |
| NaCl brine | | | | | |

### EXAMPLE 4

A comparison of the oxidation-reduction potentials of a MWSA were made to a hydrogen peroxide solution. The ORP of a MWSA was compared to the ORP of a 34% H₂O₂ solution at a pH of either 6.5 or 7.5. Samples were prepared to contain 100 g of water and the amount of either an MWSA or 34% H₂O₂ as indicated in Table 3. The pH of the samples was adjusted as indicted and the ORP before and after pH adjustment measured and are presented in Table 3.

TABLE 3

| | Dosage | | | ORP after pH | ORP after pH |
|---|---|---|---|---|---|
| | (ppm) | pH | ORP (mV) | adjusted to 6.5 | adjusted to 7.5 |
| MWSA | 50 | 6.00 | 370 | 358 | 358 |
| | 100 | 5.71 | 376 | 362 | 345 |
| | 200 | 5.14 | 403 | 380 | 333 |
| | 300 | 5.11 | 408 | 392 | 329 |
| H₂O₂ | 50 | 6.37 | 356 | 351 | 300 |
| | 100 | 6.66 | 352 | 342 | 315 |
| | 200 | 6.67 | 348 | 310 | 300 |
| | 300 | 6.48 | 351 | 320 | 302 |

The ORP measurements were observed to be slightly higher with the samples dosed with an MWSA when compared with those dosed with H₂O₂.

An MWSA, designated Sample 1, comprising an oxidizer and biochelant was prepared and the ORP of this sample was compared to that a blend of H₂O₂ and sodium chloride, designated Samples 2 and 3. The sample formulations are presented in Table 4.

TABLE 4

| | Hydrogen Peroxide | Sodium Chloride | MWSA | Deionized (DI) water |
|---|---|---|---|---|
| Chemical | Wt. % | Wt. % | Wt. % | Wt. % |
| Sample 1 | 67.65 | — | 8 | 24.35 |
| Sample 2 | 67.65 | 4 | — | 28.35 |
| Sample 3 | 67.65 | 8 | — | 24.35 |

The ORP of the samples was measured after pH adjustment as indicated in Table 5. The ORP measurements were slightly higher with Sample 1 containing an MWSA of the present disclosure.

TABLE 5

| | Initial | Initial ORP | Adjusted | ORP | Adjusted | ORP |
|---|---|---|---|---|---|---|
| Sample | pH | (mV) | pH | (mV) | pH | (mV) |
| Sample 1 | 5.52 | 408 | 6.49 | 317 | 7.51 | 214.2 |
| Sample 2 | 2.77 | 420 | 6.5 | 284 | 7.5 | 195 |
| Sample 3 | 2.73 | 426 | 6.51 | 282.1 | 7.5 | 190 |

### EXAMPLE 5

The ability of an MWSA of the type disclosed herein to function as both an iron chelator and corrosion inhibitor for acid blends was investigated. Two samples, designated Sample 3 and Sample 4, were prepared containing the type and amount of components indicated in Table 6. The protectant used was propargyl hydroxide and the surfactant was quaternary pyridium.

TABLE 6

| Sample No. | Protectant wt. % | Surfactant wt. % | Solvent wt. % | Biochelant |
|---|---|---|---|---|
| 3 | 10 | 30 | 60 | — |
| 4 | 10 | 30 | 30 | 30 |

A corrosion test was performed by preparing two beakers containing 100 mL of a 15% HCl in water and heating the solution to 65° C. Each beaker was dosed with either 4000 ppm of Sample 3 or 4000 ppm, of Sample 4 to generate Samples 5 and 6, respectively. Two coupons were cleaned by sonication with IPA, xylenes and acetone. The coupon weights were recorded and the coupons placed into Sample 5 or Sample 6 for 16 hours after which the coupons were cleaned and the weight recorded. The results are given in Table 7.

TABLE 7

| | Coupon Start | Coupon Final | |
|---|---|---|---|
| Sample | Weight (g) | Weight (g) | Weight Loss (mg) |
| 5 | 11.8706 | 11.8612 | 9.4 |
| 6 | 11.9954 | 11.9873 | 8.1 |

The results, Table 7, demonstrate that the coupon contacted with an MWSA of the type disclosed herein, Sample 4 and Sample 6, had less mass loss suggesting improved corrosion inhibition.

Samples 5 and 6 were subjected to a forced iron precipitation test (FIPT) to evaluate each samples ability to chelate iron. Samples 5 and 6, 10 mL of each, were raised from a pH of 0 to 11.50 using 25 wt. % NaOH. Sample 5 failed the FIPT due to the formation of solids. In contrast, Sample 6 showed no precipitation when raised from a pH of 0 to 11.50. The results demonstrate the sample containing an MWSA of the type disclosed exhibited improved iron chelation and corrosion inhibition.

### EXAMPLE 6

A comparison of the iron chelating ability was made and is detailed in Table 8. In Table 8 THPS refers to tetrakis(hydroxymethyl)phosphonium sulfate while EDTA refers to ethylenediaminetetraacetic acid.

TABLE 8

| | | | | | % Fe |
|---|---|---|---|---|---|
| | | | Fe mg/L | Fe mg/L @ | remaining in |
| Product | % Active | Dosage [ppm] | start | final pH | solution |
| Blank | 0% | 0 | 30 | 10.26 | 34% |
| Gluconic Acid | 30% | 120 | 30 | 26.07 | 87% |
| Gluconic Acid | 60% | 120 | 30 | 31.67 | 100% |
| 75% THPS | 75% | 120 | 30 | 0.12 | 0% |
| 40% EDTA | 40% | 120 | 30 | 18.71 | 62% |
| 50% THPS | 50% | 120 | 30 | 0.36 | 1% |

### Additional Disclosure

The following are non-limiting, specific aspects in accordance with the present disclosure:

A first aspect which is a multifunctional wellbore servicing additive composition comprising a biochelant and at least one compound selected from the group consisting of acid, oxidizer, protectant, and surfactant.

A second aspect which is the composition of the first aspect wherein the biochelant comprises an aldonic acid, uronic acid, aldaric acid or combinations thereof.

A third aspect which is the composition of any of the first through second aspects wherein the biochelant further comprises a counter cation.

A fourth aspect which is the composition of the third aspect wherein the counter cation comprises an alkali metal, an alkali earth metal or combinations thereof.

A fifth aspect which is the composition of any of the third through fourth aspects wherein the counter cation comprises sodium, potassium, magnesium, calcium, strontium, cesium or combinations thereof

A sixth aspect which is the composition of any of the first through fifth aspects wherein the biochelant comprises a buffered glucose oxidation product, a buffered gluconic acid oxidation product or combinations thereof.

A seventh aspect which is the composition of the sixth aspect wherein the buffered glucose oxidation product, the buffered gluconic acid oxidation product or combinations thereof is buffered to a pH of from about 0.5 to about 5.5.

An eighth aspect which is the composition of any of the s0069xth through seventh aspects wherein the buffered glucose oxidation product, the buffered gluconic acid oxidation product or combinations thereof further comprises n-keto-acids, C2-C5 diacids or combinations thereof.

A ninth aspect which is the composition of any of the first through eighth aspects wherein the biochelant is present in the composition in the amount of from about 1 wt. % to about 70 wt. % based on the total weight of the composition.

A tenth aspect which is the composition of any of the first through ninth aspects wherein the acid comprises hydrochloric acid, hydrobromic acid, sulfuric acid, nitric acid, phosphoric acid, boric acid, malonic acid, citric acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid or combinations thereof

An eleventh aspect which is the composition of any of the first through tenth aspects wherein the acid comprises a terminal monoacid, a terminal diacid or combinations thereof having from about 3 carbon atoms to about 18 carbon atoms.

A twelfth aspect which is the composition of any of the first through eleventh aspects wherein the oxidizer comprises hydrogen peroxide, dicumyl peroxide, benzoyl peroxide, di-t-butyl peroxide, t-butyl hydroperoxide, a per-carboxylic acid, a peroxy acid, a perester, dialkyl peroxides, 2,5-dimethyl-2,5-di-(t-butylperoxy) hexane, diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, t-amyl peroxides, n-butyl-4,4-di-(t-butyl peroxy) valerate, di-t-butyl peroxide, 2,5-dimethyl-2,5-di-(t-butylperoxy) hexane (DHBP), diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, diacyl peroxides, t-amyl peroxides, n-butyl-4,4-di-(t-butyl peroxy) valerate, or combinations thereof.

A thirteenth aspect which is the composition of any of the first through twelfth aspects wherein the oxidizer comprises hydrogen peroxide.

A fourteenth aspect which is the composition of any of the first through thirteenth aspects wherein the oxidizer is characterized by the general formula Y.nH₂O.mH₂O₂ wherein Y is a salt; n is equal to or greater than zero; and m is equal to or greater than 1.

A fifteenth aspect which is the composition of any of the first through fourteenth aspects wherein the surfactant comprises ethoxylated nonyl phenol phosphate esters, nonionic surfactants, cationic surfactants, anionic surfactants, amphoteric/zwitterionic surfactants, sulfonated olefins, alkyl glucoside, quaternary amine, alkyl phosphonium chloride, alkyl phosphonate surfactants, linear alcohols, nonylphenol compounds, alkyoxylated fatty acids, alkylphenol alkoxylates, ethoxylated amides, betaines, methyl ester sulfonates, hydrolyzed keratin, sulfosuccinates, taurates, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, quaternary ammonium compounds, trimethyltallowammonium chloride, trimethylcocoammonium chloride, quaternary alkyl ammonium chloride, alkyl phosphonium chloride, propargyl alcohol, acetylenic alcohol, phosphate esters, quaternary amines, imidazolines, amine salts, amide salts or combinations thereof.

A sixteenth aspect which is the composition of any of the first through fifteenth aspects wherein the protectant comprises phosphonates, organic acids, polymeric organic acids, polycarboxylics, ATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid, sodium aspartic acid, phosphinocarboxylates, AA-AMPS (acrylic acid-2-acrylamido-2-methylpropane sulfonic acid), phosphonate esters, cocamines, fatty acid amides, fatty acid derived imidazoles, acetylenic alcohol, thiazoles, triazoles, pyrazoles acetylenic acid, phosphate esters, poly/orthophosphates, phosphonates, zinc, nitrite, molybdate compounds, azoles, silicates, pyridines, pyridine derivatives or combinations thereof

A seventeenth aspect which is composition of any of the first through sixteenth aspects wherein the composition further comprises a solvent.

An eighteenth aspect which is the composition of the seventeenth aspect wherein the solvent comprises methanol, ethanol, propanol, butanol, pentanol, isopropanol, ethylene glycol, propylene glycol or a combination thereof.

A nineteenth aspect which is the composition of any of the seventeenth through eighteenth aspects wherein the solvent comprises water.

A twentieth aspect which is a method of servicing an oilwell comprising placing downhole a composition comprising a biochelant and at least one compound selected from the group consisting of acid, oxidizer, protectant, and surfactant.

A twenty-first aspect which is the method of the twentieth aspect wherein the composition is placed downhole during a well completion operation.

While aspects of the disclosure have been shown and described, modifications thereof can be made without departing from the spirit and teachings of the presently disclosed subject matter. The aspects and examples described herein are exemplary only, and are not intended to be limiting. Many variations and modifications of the subject matter disclosed herein are possible and are within the scope of the present disclosure.

At least one aspect is disclosed and variations, combinations, and/or modifications of the aspect(s) and/or features of the aspect(s) made by a person having ordinary skill in the art are within the scope of the disclosure. Alternative aspects that result from combining, integrating, and/or omitting features of the aspect(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, 5, 6, . . . ; greater than 0.10 includes 0.11, 0.12, 0.13, 0.14, 0.15, . . .). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k* (Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent . . . 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the detailed description of the presently disclosed subject matter.

1. A multifunctional wellbore servicing additive composition comprising a biochelant and at least one compound selected from the group consisting of acid, oxidizer, protectant, and surfactant.

2. The composition of claim 1, wherein the biochelant comprises an aldonic acid, uronic acid, aldaric acid or combinations thereof.

3. The composition of claim 1, wherein the biochelant further comprises a counter cation.

4. The composition of claim 3, wherein the counter cation comprises an alkali metal, an alkali earth metal or combinations thereof.

5. The composition of claim 3, wherein the counter cation comprises sodium, potassium, magnesium, calcium, strontium, cesium or combinations thereof.

6. The composition of claim 1, wherein the biochelant comprises a buffered glucose oxidation product, a buffered gluconic acid oxidation product or combinations thereof.

7. The composition of claim 6, wherein the buffered glucose oxidation product, the buffered gluconic acid oxidation product or combinations thereof is buffered to a pH of from about 0.5 to about 5.5.

8. The composition of claim 6, wherein the buffered glucose oxidation product, the buffered gluconic acid oxidation product or combinations thereof further comprises n-keto-acids, C2-C5 diacids or combinations thereof.

9. The composition of claim 1 wherein the biochelant is present in the composition in the amount of from about 1 wt. % to about 70 wt. % based on the total weight of the composition.

10. The composition of claim 1, wherein the acid comprises hydrochloric acid, hydrobromic acid, sulfuric acid, nitric acid, phosphoric acid, boric acid, malonic acid, citric acid, tartartic acid, glutamic acid, phthalic acid, azelaic acid, barbituric acid, benzilic acid, cinnamic acid, fumaric acid, glutaric acid, gluconic acid, hexanoic acid, lactic acid, malic acid, oleic acid, folic acid, propiolic acid, propionic acid, rosolic acid, stearic acid, tannic acid, trifluoroacetic acid, uric acid, ascorbic acid, gallic acid or combinations thereof.

11. The composition of claim 1, wherein the acid comprises a terminal monoacid, a terminal diacid or combinations thereof having from about 3 carbon atoms to about 18 carbon atoms.

12. The composition of claim 1, wherein the oxidizer comprises hydrogen peroxide, dicumyl peroxide, benzoyl peroxide, di-t-butyl peroxide, t-butyl hydroperoxide, a per-carboxylic acid, a peroxy acid, a perester, dialkyl peroxides, 2,5-dimethyl-2,5-di-(t-butylperoxy) hexane, diacyl peroxides, dilauroyl peroxide, dibenzoyl peroxide, peroxyesters, t-butyl peroxy-2-ethylhexanoate, OO-(t-butyl)-O-(2-ethylhexyl) peroxycarbonate, t-butyl peroxy-3,5,5-trimethylhexylhexanoate, t-butyl peroxy benzoate, diperoxyketals, t-amyl peroxides, n-butyl-4,4-di-(t-butyl peroxy) valerate, di-t-butyl peroxide, 2,5-dimethyl-2,5-di-(t-butylperoxy) hexane (DHBP), diacyl peroxides, dilauroyl peroxide, dibenzoyl peroxide, peroxyesters, t-butyl peroxy-2-ethyl hexanoate, OO-(t-butyl)-O-(2-ethylhexyl) peroxycarbonate, t-butyl peroxy-3,5,5-trimethylhexylhexanoate, t-butyl peroxy benzoate, diperoxyketals, diacyl peroxides, t-amyl peroxides, n-butyl-4,4-di-(t-butyl peroxy) valerate, or combinations thereof.

13. The composition of claim 1, wherein the oxidizer comprises hydrogen peroxide.

14. The composition of claim 1, wherein the oxidizer is characterized by the general formula Y.nH₂O.mH₂O₂
wherein Y is a salt;
n is equal to or greater than zero; and
m is equal to or greater than 1.

15. The composition of claim 1, wherein the surfactant comprises ethoxylated nonyl phenol phosphate esters, nonionic surfactants, cationic surfactants, anionic surfactants, amphoteric/zwitterionic surfactants, sulfonated olefins, alkyl glucoside, quaternary amine, alkyl phosphonium chloride, alkyl phosphonate surfactants, linear alcohols, nonylphenol compounds, alkyoxylated fatty acids, alkylphenol alkoxylates, ethoxylated amides, betaines, methyl ester sulfonates, hydrolyzed keratin, sulfosuccinates, taurates, amine oxides, alkoxylated alcohols, lauryl alcohol ethoxylate, ethoxylated nonyl phenol, ethoxylated fatty amines, ethoxylated alkyl amines, cocoalkylamine ethoxylate, modified betaines, alkylamidobetaines, cocoamidopropyl betaine, quaternary ammonium compounds, trimethyltallowammonium chloride, trimethylcocoammonium chloride, quaternary alkyl ammonium chloride, alkyl phosphonium chloride, propargyl alcohol, acetylenic alcohol, phosphate esters, quaternary amines, imidazolines, amine salts, amide salts or combinations thereof.

16. The composition of claim 1, wherein the protectant comprises phosphonates, organic acids, polymeric organic acids, polycarboxylics, ATMP (aminotrimethylene phosphonic acid), HEDP (1-hydroxyethylidene-1,1-diphosphonic acid), HPMA (Hydrolzed Polymaleic Anhydride), HPAA (2-hydrophosphonocarboxylic), PAPEMP (polyamino polyether phosphonate), AEEA (aminoethlethanolamine), DTPMP (diethylenetriamine penta is a phosphonic acid), BHMT (Bis(HexaMethylene Triamine Penta (Methylene Phosphonic Acid))), BTPMP (Diethylene Triamine Penta (Methylene Phosphonic Acid), PBTC (2-phosphonobutane-1,2,4-tricarboxylic acid), polymacrylates, maleic acid, polyaspartic acid, sodium aspartic acid, phosphinocarboxylates, AA-AMPS (acrylic acid-2-acrylamido-2-methylpropane sulfonic acid), phosphonate esters, cocamines, fatty acid amides, fatty acid derived imidazoles, acetylenic alcohol, thiazoles, triazoles, pyrazoles acetylenic acid, phosphate esters, poly/orthophosphates, phosphonates, zinc, nitrite, molybdate compounds, azoles, silicates, pyridines, pyridine derivatives or combinations thereof

17. The composition of claim 1, wherein the composition further comprises a solvent.

18. The composition of claim 17, wherein the solvent comprises methanol, ethanol, propanol, butanol, pentanol, isopropanol, ethylene glycol, propylene glycol or a combination thereof.

19. The composition of claim 17, wherein the solvent comprises water.

20. A method of servicing an oilwell comprising:
placing downhole a composition comprising a biochelant and at least one compound selected from the group consisting of acid, oxidizer, protectant, and surfactant.

21. The method of claim 20, wherein the composition is placed downhole during a well completion operation.
